(19) United States
(12) Patent Application Publication
(10) Pub. No.: US 2024/0399615 A1
(43) Pub. Date: Dec. 5, 2024

(54) ROBOTIC ASSEMBLY OF MASS TIMBER STRUCTURAL PANELS

(71) Applicant: INTELLIGENT CITY INC., VANCOUVER (CA)

(72) Inventors: OLIVER LANG, VANCOUVER (CA); CYNTHIA WILSON, VANCOUVER (CA); OLIVER DAVID KRIEG, VANCOUVER (CA); AARON WILLETTE, VANCOUVER (CA); STUART LODGE, VANCOUVER (CA); NICHOLAS HAMEL, VANCOUVER (CA)

(21) Appl. No.: 18/698,974

(22) PCT Filed: Oct. 13, 2022
(86) PCT No.: PCT/CA2022/051503

§ 371 Date: Apr. 5, 2024

Related U.S. Application Data
(60) Provisional application No. 63/262,464, filed on Oct. 13, 2021.

(51) Int. Cl. B27M 3/04; B25J 11/00; B27M 3/00; E04B 2/00; E04C 2/12

(52) U.S. Cl. CPC B27M 3/04; B25J 11/005; B27M 3/0073; E04C 2/12; E04C 2/46

(57) ABSTRACT

An automated method and system for manufacturing prefabricated mass timber floor and wall panels, where one or more robots are utilised to assemble (through a combination of picking/placing, gluing and nailing) building parts into a structural panel on an assembly table. A flexible and adaptable method for manufacturing prefabricated mass timber structural panels of different dimensions and make-up. The structural panels comprise a top segmented skin consisting of a number of subpanels, an interstitial layer consisting of a number of interstitial ribs, and a bottom segmented skin consisting of a number of subpanels; the subpanels of one or both layers are connected by glued splines connections and by nailing to the overlapping interstitial ribs.

### FIELD OF THE INVENTION

The present invention relates to the field of mass timber structural panels used in building construction. More specifically, the present invention relates to methods and systems for the automated assembly and manufacture of mass timber structural panels using robots, and to mass timber structural panels manufactured using such methods/systems.

### BACKGROUND OF THE INVENTION

Mass timber is increasingly used in construction for multi-storey buildings. (“Mass timber” as used herein is intended to encompass mass timber and engineered timber). In particular, the use of mass timber in prefabricated construction for the structural system of high/mid-rise buildings is increasingly being considered, due to mass timber's fire resistance and structural strength. As has been shown with other construction materials and systems, a high degree to prefabrication for the walls and floors/ceilings of a multi-storey building, can make the construction process more efficient. Further, this often allows for a quick building envelope enclosure (which can for example reduce the risk of water/weather damage to the building structure)—all of which may be desirable to manufacturers for certain types of construction projects. In recent applications, such prefabricated mass timber construction elements (i.e. walls and ceilings/floors) may be in the form of mass timber structural panels, which may generally be cassette-like or double-layered (or even multi-layered)—comprising for example a bottom skin or layer, an interstitial layer, and a top skin or layer. U.S. patent application Ser. No. 16/973,997 (Publication No. US 2021/0123237) discloses some examples of such structural panels.

It is contemplated that the assembly or manufacture of such mass timber structural panels may benefit from automation using industrial robots.

First of all, it should be appreciated that the use of mass timber in prefabrication construction for structural elements (such as walls and floors) in multi-storey buildings is itself a significant departure from conventional approaches. Despite the potential attractiveness from an environmental perspective of using mass timber for construction, it has not until very recently been conventionally used for multi-storey construction. The decision to use mass timber as the primary material in multi-storey construction can give rise to host of considerations. It should also be appreciated that from a construction standpoint, mass timber is significantly different from light wood construction, for example—it is not simply a case of substituting mass timber for a conventionally used material.

When it comes to automation approaches in construction of timber frame walls, this typically has been limited to using equipment to pick up and place lightweight dimensional lumber to construct such timber frame walls. The approach has centred upon automating manual assembly methods, where the process steps are equal or similar to traditional manual labour. Conventionally, timber frame walls or floors have only been used for lightweight wood construction, such as for single family homes or low-rise multi-storey buildings. When it comes to multi-storey (high-rise/mid-rise) buildings, the construction of structural components (walls and floors) involves use of mass timber, which involves a different construction method and approach, since the structural components are very heavy and rigid, and on an entirely different scale. To date, there has been a general lack of automation in mass timber construction, and this comes from a combination of lack of equipment, processes, and appropriate construction systems. Further, the need for flexibility to accommodate different building designs has so far made industrialization of such construction even more difficult. In a departure from conventional thinking, when building components are developed in conjunction with heavy automation equipment (industrial robots), their make-up, connections, and sizes, leaves the realm of capabilities of manual or human labor.

### SUMMARY OF THE INVENTION

Disclosed herein is an automated and flexible method for the manufacturing of prefabricated “hollow” mass timber floor and wall panels (“structural panels”), where one or more robots are utilised to assemble (through a combination of picking/placing, gluing and nailing) mass timber parts into a larger building component corresponding to a structural panel on a horizontal assembly table.

Also disclosed herein is a flexible and adaptable manufacturing method which allows for automated prefabrication of large-scale mass timber components that can differ in their dimensions and make-up because their underlying sub-routines are similar in logic but flexible in their coordinates.

Also disclosed herein are prefabricated mass timber structural panels manufactured according to the described assembly methods and systems.

In accordance with an aspect of the present invention, disclosed herein is a structural panel made substantially from mass timber for use as a flooring panel or wall panel, having (i) a bottom segmented layer comprising a plurality of planar bottom subpanels, arranged side-by-side and oriented in line with the transverse axis of the structural panel, with each bottom subpanel fixedly connected to one or more of its respective adjacent bottom subpanels; (ii) a top segmented layer comprising a plurality of planar top subpanels, arranged side-by-side, and oriented in line with the transverse axis, with each top subpanel fixedly connected to one or more of its respective adjacent top subpanels; and (iii) an interstitial layer disposed between the bottom segmented layer and the top segmented layer, the interstitial layer comprising a plurality of elongate interstitial ribs oriented generally in line with an longitudinal axis of the structural panel, and defining a space between the bottom segmented layer and the top segmented layer, each of the interstitial ribs spanning over two or more of the bottom subpanels and over two or more of the top subpanels, and fixedly connected to the bottom segmented layer and to the top segmented layer; wherein each bottom subpanel is fixedly connected to its adjacent bottom subpanels by one or more bottom spline connections; and wherein each top subpanel is fixedly connected to its adjacent top subpanels using a plurality of crossing nail connections or optionally using one or more top spline connections.

In some aspects, the bottom spline connections may be a bottom spline overlapping said bottom subpanel and its adjacent bottom subpanel and fixedly connected to the bottom subpanel and its adjacent bottom subpanel with adhesive.

In yet other aspects, the bottom spline connections may comprise a first bottom spline pocket disposed proximate a side edge of the bottom subpanel, a corresponding second bottom spline pocket disposed proximate an adjacent side edge of the adjacent bottom subpanel, and a bottom spline insert, wherein the first bottom spline pocket and second bottom spline pocket are configured to receive the bottom spline insert; and wherein the bottom spline insert overlaps said bottom subpanel and its adjacent bottom subpanel and is fixedly connected to the bottom subpanel and its adjacent bottom subpanel with adhesive.

In yet other aspects, the top surface of the bottom spline insert is flush with the top surface of the bottom segmented skin.

In some aspects, the interstitial ribs are fixedly connected to the bottom segmented layer and the top segmented layer using nails. In yet other aspects, the interstitial ribs are fixedly connected to the bottom segmented layer by crossing nail connections applied proximate to a bottom interface between said interstitial rib and the bottom segmented layer, and the interstitial ribs are fixedly connected to the top segmented layer by crossing nail connections applied proximate to a top interface between said interstitial rib and the bottom segmented layer.

In some aspects, the structural panel is for use as a flooring panel or wall panel for a multi-storey building.

In yet other aspects, the bottom subpanels and top subpanels are made substantially from mass timber.

In accordance with another aspect of the present invention, disclosed herein is a method for constructing a structural panel made substantially from mass timber, for use as a flooring panel or as a wall panel, comprising the steps of: (i) orienting a plurality of mass timber bottom subpanels in line with a transverse axis of the structural panel and positioning the bottom subpanels side-by-side in a first plane upon an assembly table; (ii) connecting the bottom subpanels to one or more of its respective adjacent bottom subpanels to form a bottom segmented layer, using one or more bottom spline connections, by applying adhesive to the spline connections using gluing means; (iii) positioning a plurality of elongate interstitial ribs atop the bottom segmented layer to form an interstitial layer, the interstitial ribs oriented generally in line with a longitudinal axis of the structural panel and spanning over two or more of the plurality of bottom subpanels; (iv) fixedly connecting the interstitial ribs to the bottom segmented layer by applying nails through the interstitial ribs and the bottom segmented layer using nailing means; (v) orienting a plurality of top subpanels in line with the transverse axis of the structural panel, and positioning the top subpanels atop the interstitial layer, side-by-side in a second plane, wherein the second plane is parallel with the first plane; (vi) fixedly connecting the interstitial ribs to the top segmented layer by applying nails through the interstitial ribs and the top segmented layer using nailing means; and (vii) fixedly connecting each of the top subpanels to its respective adjacent top subpanels to form a top segmented layer, either by applying crossing nail connections along a respective seam between each top subpanel and its respective adjacent top subpanel or optionally by using one or more top spline connections and applying adhesive to the top spline connections using gluing means.

In another aspect, the interstitial ribs are connected to the bottom segmented layer by applying crossing nail connections proximate to a bottom interface therebetween. In yet another aspect, the interstitial ribs are connected to the top segmented layer by applying crossing nail connections proximate to a top interface between each said interstitial rib and the top segmented layer.

In another aspect, the bottom spline connection involves a first bottom spline pocket disposed proximate a side edge of the bottom subpanel, and a corresponding second bottom spline pocket disposed proximate an adjacent side edge of the adjacent bottom subpanel, and a bottom spline insert, wherein the first bottom spline pocket and second bottom spline pocket are configured to receive the bottom spline insert, and the method involves affixing the bottom spline insert to the first bottom spline pocket and the second bottom spline pocket with adhesive, such that the bottom spline insert overlaps the bottom subpanel and its adjacent bottom subpanel and is fixedly connected to the bottom subpanel and its adjacent bottom subpanel.

In accordance with another aspect of the present invention, disclosed herein is a method for constructing a structural panel where the steps of orienting, position, nailing and applying adhesive are carried out by a robot equipped with one or more of a gripping means, effector means, nailing means and gluing means, the robot configured to move along a track disposed alongside the assembly table for assembling the structural panel.

In another aspect, disclosed herein is a structural panel constructed and assembled in accordance with the aforementioned methods.

### BRIEF DESCRIPTION OF THE DRAWINGS

FIG. 1 is a perspective view of an exemplary embodiment of the robotic assembly system for carrying out the process of the present invention.

FIG. 2 is a perspective view of the robotic assembly system of FIG. 1, showing the robot positioning multiple construction parts or subpanels (which make up the bottom segmented skin) side by side.

FIG. 3 is a perspective view of an exemplary industrial robot for carrying out the described assembly process.

FIG. 4 is a perspective view of the robotic assembly system of FIG. 1, showing the robot applying glue to a spline pocket of two adjacent subpanels (of the bottom segmented skin).

FIG. 5 is a perspective view of the robotic assembly system of FIG. 1, showing the robot picking up a spline from a spline stack.

FIG. 6 is a perspective view of the robotic assembly system of FIG. 1, showing the robot placing a spline into a glued spline pocket.

FIG. 7 is a perspective view of the robotic assembly system of FIG. 1, showing the robot nailing a spline to two adjacent subpanels (making up part of the bottom segmented skin).

FIG. 8 is a perspective view of the robotic assembly system of FIG. 1, showing the robot applying glue to a rib location on the bottom segmented skin.

FIG. 9 is a perspective view of the robotic assembly system of FIG. 1, showing the robot picking up a rib from the rib stack.

FIG. 10 is a perspective view of the robotic assembly system of FIG. 1, showing the robot placing a rib at a rib location on the bottom segmented skin.

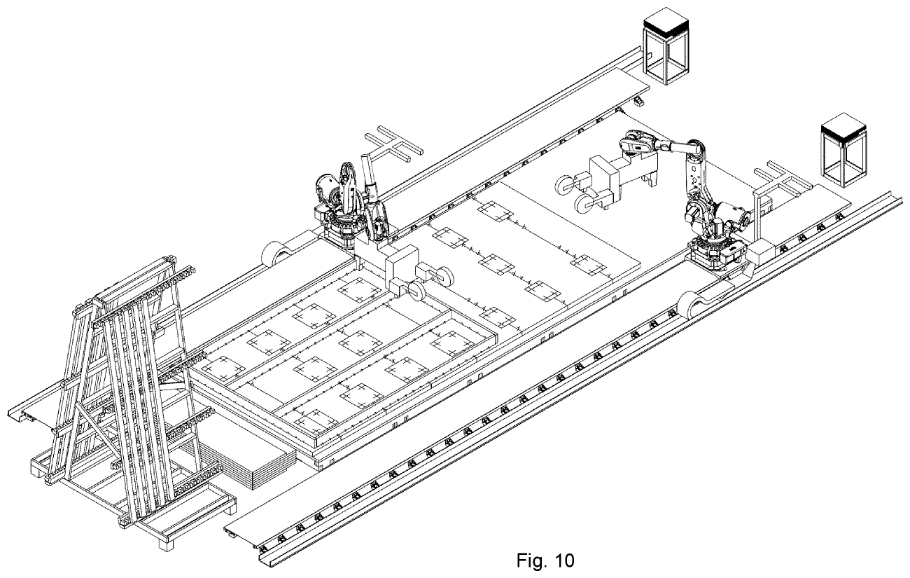

FIG. 11 is a perspective view of the robotic assembly system of FIG. 1, showing the robot nailing the placed rib to the bottom segmented skin.

FIG. 12 is a perspective view of the robotic assembly system of FIG. 1, showing the robot applying adhesive on the top of a nailed rib.

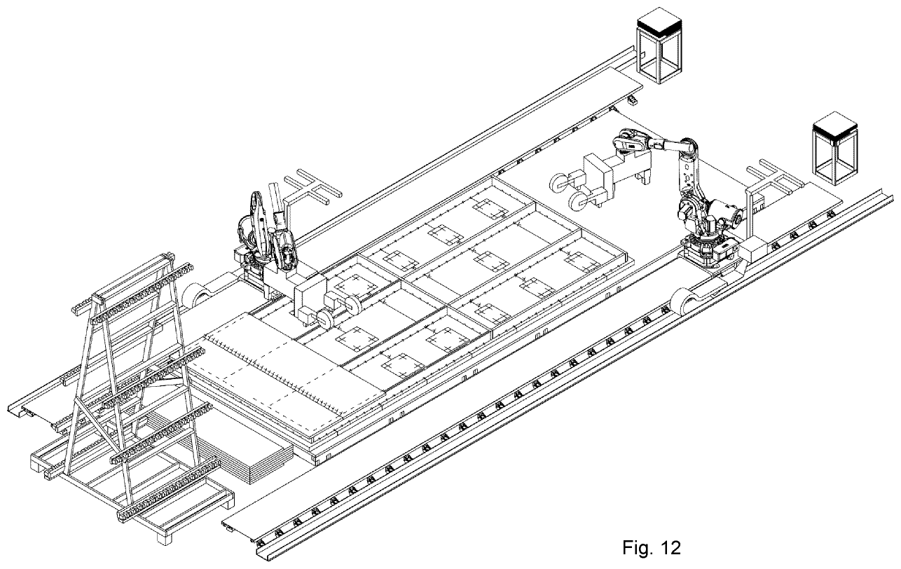

FIG. 13 is a perspective view of the robotic assembly system of FIG. 1, showing the robot picking up one of a number of subpanels (which make up the top segmented skin).

FIG. 14 is a perspective view of the robotic assembly system of FIG. 1, showing the robot positioning multiple subpanels (which make up the top segmented skin) side by side.

FIG. 15 is a perspective view of the robotic assembly system of FIG. 1, showing the robot nailing a subpanel making up the top segmented skin to the nailed ribs.

FIG. 16 is a perspective view of the robotic assembly system of FIG. 1, showing the robot nailing the subpanels of the top segmented skin together.

FIG. 17 is a side elevation view of a robot equipped with nailing means for nailing building parts together.

FIG. 18 is a perspective view of the robotic assembly system of FIG. 1, shown in use in the construction of an alternative design of a structural panel.

FIG. 19 is a perspective view of the robotic assembly system of FIG. 1, shown in use in the construction of an alternative design of a structural panel.

### DETAILED DESCRIPTION OF THE INVENTION

A detailed description of one or more embodiments of the present invention is provided below along with accompanying figures that illustrate the principles of the invention. As such, this detailed description illustrates the present invention by way of example and not by way of limitation. The description will clearly enable one skilled in the art to make and use the invention, and describes several embodiments, adaptations, variations and alternatives and uses of the invention, including what is presently believed to be the best mode and preferred embodiment for carrying out the invention. It is to be understood that routine variations and adaptations can be made to the invention as described, and such variations and adaptations squarely fall within the spirit and scope of the invention. For the purpose of clarity, technical material that is known in the technical fields related to the invention has not been described in detail so that the invention is not unnecessarily obscured.

Described and illustrated herein is a process for the automated assembly of prefabricated double-layered (or cassette-like) floor panels and wall panels (generally referred to herein as “structural panels”) made from mass timber, utilising one or more industrial robots. Also disclosed herein, is a preferred embodiment of a system for carrying out said assembly process. While the structural panels are generally described and illustrated herein as panel systems, it should be understood that these structural panels may include additional features such as penetrations, ducting, electrical conduits, or insulation and may encompass more complex designs such as angled or tapered edges). The structural panels are of substantial size (given that they generally correspond to whole or partial sections of walls/floors of multi-storey buildings). This means that the mass timber component parts from which the structural panels are assembled, are also generally of a size, weight, shape, and topology that is very substantial and which cannot generally be handled by a human worker. While current technology in construction is focused on automating previously manual processes, moving away from processes, connection details, and building parts that are within a typical human worker's size and weight range means that only industrial equipment can be used.

It should be appreciated that the present invention disclosed herein is generally developed for the assembly and manufacture of said structural panels, and is generally discussed and illustrated herein in such context. Such structural panels are generally contemplated as being made substantially from mass timber, although it is to be understood that the construction elements may also be made from mass timber combined with other typical construction/building materials.

The disclosed process was particularly developed for the assembly of a double-layered floor or wall panel that is made from a bottom segmented skin (or bottom layer), an interstitial layer, and a top segmented skin (or top layer). Together, these elements form a hollow-core cassette construction that can be used in high-rise/mid-rise and long span applications for both floors and wall sections. The bottom skin may be made from up to a dozen individual mass timber construction parts (generally referred to herein as “subpanels”) that are connected together using glued and nailed spline inserts. The subpanels making up the bottom skin may be of different sizes, although it is generally preferable that they be of similar, if not identical, size. The subpanels may be made from cross-laminated timber (“CLT”). The spline inserts (sometimes referred to herein simply as “splines”) ensure a continuous material connection along the length of the bottom skin. The interstitial layer is made from up to two dozen vertical engineered timber ribs that are glued and nailed to the bottom layer. The top skin is made from up to a dozen individual mass timber subpanels that are connected to the interstitial layer with adhesive and nails, and connected to each other with a cross-nailed connection. (The subpanels making up the top skin may be of different sizes, e.g. to accommodate structural requirements of their connections' locations). In some cases, the top segmented skin can also be connected with the above-mentioned spline inserts if a continuous material connection is required.

In order to pick up, manoeuvre and assemble building parts of this size and weight range, one or more industrial robot arms with specifically developed effectors are required. The basic functions required to be performed by the one or more robots include: picking-up, placing/positioning, gluing and nailing. The specification, mechanics, electronics, movement patterns and functions are interrelated to the assembly process, its flexibility, and the building components that are assembled.

An important aspect of the present innovation is the flexibility of the assembly process and its consequences on the layout and process. The number, size and weight of each building part is not defined by a single number, but rather by a range, in order to allow for a wider range of geometric adaptability of the building structural panels that are produced in this process. In the present case, the assembled structural panels may range in size anywhere between 6 and 14 feet in width, 16 to 53 feet in length, and 6 to 24 inches in height or thickness. Consequently, each building part that is robotically placed and joined in the process can also vary in its dimensions. The configuration and layout of the process allows for subpanels (which primarily make up each structural panel) to range between 1 and 8 ft in width, 6 to 20 ft in length, and 2 to 6 inches in thickness, and weigh up to 500 Kg.

Some of the more significant aspects of the present invention are outlined below.

### Parametric Machine Code Generation

The software workflow, and ultimately, the assembly process and layout, is referred to as “parametric” because building parts and process steps are not defined by specific dimensions or movement instructions but rather by their underlying logic. Individual manifestations of this logic are applied when a specific structural subpanel is being designed. At this point, the number of parts and their dimensions is defined based on the design of a building, and therefore of the building components and parts.

From a parametric software workflow that incorporates all possible permutations of the described structural panel, all specific part data is extracted and prepared for machine code generation by saving an individual structural panel design, or assembly job, into a separate file or data stream.

Each part comes with its own set of logical assembly instructions that relate to the process. One portion of these instructions is based on repeatable sub-routines, while a second portion is based on parametric instructions, or flexible instructions, that depend on the location of the part inside the structural panel, and on the dimensions of the part.

A software process reads out the sequence of all building parts and their assembly instructions, arranges them in sequence of assembly, and generates machine code that can be read by the robot system for the assembly process.

Because each specific design of a structural panel is different from another, the assembly process is also never exactly the same-new machine code will be generated with every job, and the robot movement may be different every time. However, the process is based on a shared logic, which can also be called a software platform, or process platform.

### General Process Layout

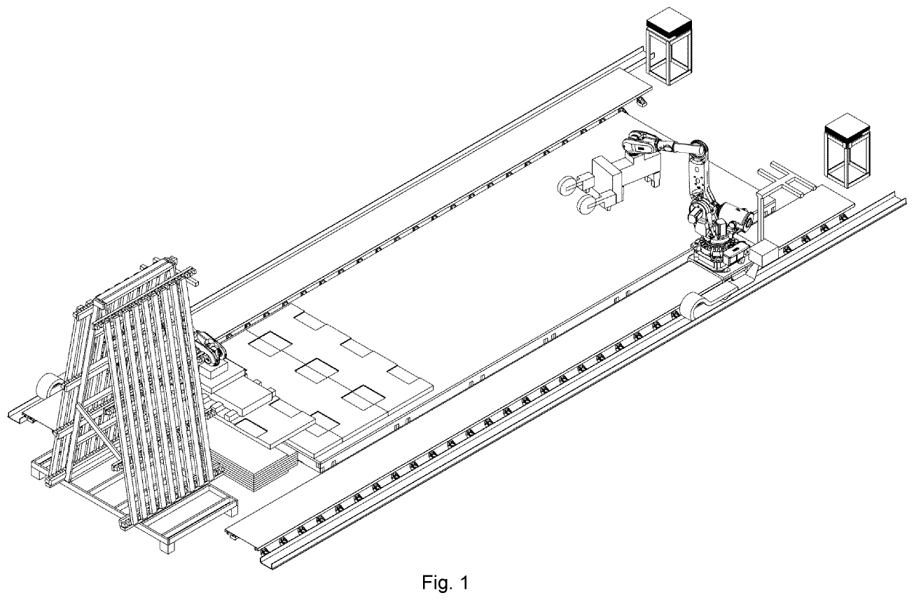

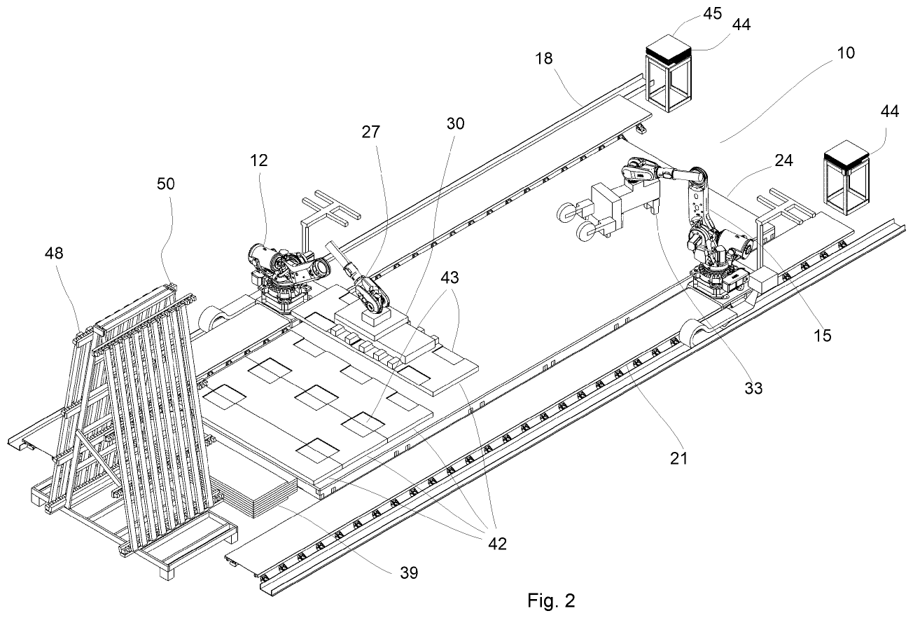

Referring to FIGS. 1 and 2, these illustrate an exemplary embodiment of the robotic assembly system for carrying out the disclosed assembly process.

At least one industrial robot 12, 15 (equipped with one or multiple effectors 27 that can accommodate the below described functions of picking/placing (i.e. picking up/lifting and placing/positioning the building parts), gluing (i.e. applying adhesive/glue), and nailing. The robot is programmed with suitable control software to carry out the operations of the assembly process described herein. The robot 12, 15 is mounted on a linear track 18, 21, which generally runs parallel to the long edge of a horizontal assembly table 24. The robot or robots can move along their respective linear tracks during the assembly process. The assembly table 24 is at least the size of the largest possible structural panel assembly. In the embodiment shown, the assembly table may be 13.5 ft wide and 45 ft long. Any of a number of commercially available industrial robots may be suitable for use in the present system, including for example, model IRB6700-300/2.7, available from ABB. The load-carrying capacity of a robot is a key consideration in the overall assembly process (although it is not necessarily a limiting factor as such (in that increasingly larger and stronger robots, or a combination of multiple robots working together, can be used)); this can determine the maximum size/weight/dimensions of the subpanels being used in the assembly process.

For ease of reference, the various operations of the assembly process are generally shown in the figures as being carried out by one single robot 12, with the other robot 15 shown as being idle. However, it should be understood that multiple robots may be utilized together to carry out the operations of the assembly process in parallel. The robots may each carry out separate functions or different steps in the assembly process, or they may work cooperatively on the same step (for example, for the step of nailing a number of subpanels together, the task may be shared among two or more robots for greater speed/efficiency—e.g., robots can work from different ends of the assembly table, thus limiting the extent to which any robot may be required to move around or reach across to another side of the assembly table).

The linear track 18, 21 is generally longer than the assembly table 24 so that the industrial robot 12, 15 can extend beyond the assembly table if required, and reach into an area that is in front of (or behind) the assembly table.

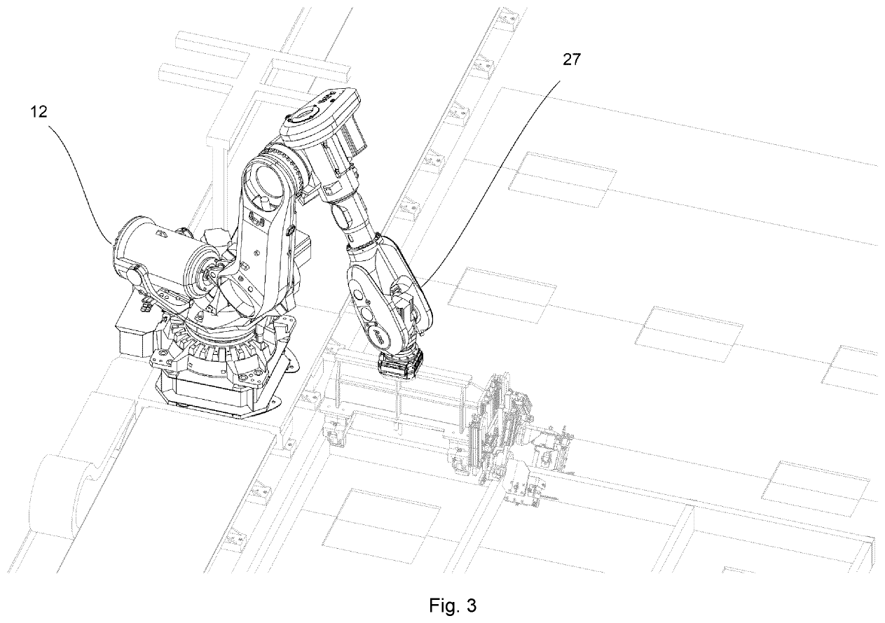

In order to accommodate the different functions listed above, the industrial robot 12 can change its end-of-arm-tooling, or effector 27, to switch between the different functions. Accordingly, the effector 27 or the robot 12 may be equipped with one or more of: a gripping means 30—essentially for picking up and placing/positioning subpanels and other building parts used in the assembly process; gluing means 33—essentially an applicator for applying adhesive to the various building parts; and nailing means 36—essentially a tool (such a pneumatic nail gun) for nailing the various building parts together. Note, in most of the figures herein, the action being carried out by a robot is depicted using the effector only, without the body that connects the effector to the base of the robot—so that certain details are not unnecessarily obscured. FIG. 3, however, shows in closer detail, an example of the industrial robot 12.

In a preferred embodiment of the process, two smaller industrial robots are placed in their individual linear tracks on either of the long sides of the assembly table (as shown, for example, in FIG. 2). In this case, both robots are able to execute the above-mentioned functions, although only one robot needs to be capable of picking up, lifting, and placing the subpanels of the bottom and top skin.

In another embodiment of this process, more than one robot can be mounted on each linear track so that the tasks can be split between multiple robots in order to accelerate the overall process.

In yet another embodiment, one or more of the robots may be equipped with multiple effectors, each effector equipped to carry out at least one of the different functions of picking up/placing, gluing and nailing, thus dispensing with the need to retool the effector during the assembly process.

In yet another embodiment, multiple robots may be provided, each of which is equipped to carry out one of the required functions of picking up/placing, gluing and nailing.

### Assembly Process

An example of the overall assembly process is described in greater detail below. This may be thought of as several general stages or subprocesses, namely: (a) material loading; (b) bottom segmented skin assembly; (c) interstitial rib assembly; and (d) top segmented skin assembly.

### Material Loading

i. Bottom and top skin: building parts for the bottom and top skin (i.e. subpanels) are loaded for the assembly process in a similar fashion, since they are both plate-based building parts that are planar but possibly with different dimensions. The subpanels 42 are loaded on top of each other in a subpanel stack 39, and in reverse sequence of assembly, with top subpanel being the first one to be assembled. In practice, the subpanel stack 39 may be in the form of the stack of subpanels suitably stacked on a wheeled cart that can be pulled in and out of the assembly line as needed. The subpanels are generally pre-stacked in the desired order before the subpanel stack is wheeled and loaded into the assembly line.
ii. Spline connections: In order to achieve a structurally continuous material connection between the individual subpanels of the bottom and/or top segmented skin, adjacent subpanels are connected together using a number of spline inserts (“splines”), which will overlap adjacent subpanels. In the example illustrated, splines are generally only shown used with the subpanels of the bottom segmented skin 51; however, it is contemplated that splines may also be used with the subpanels of the top segmented skin 57. Where the use of splines is contemplated, each subpanel is preferably provided with one or more partial spline pockets, which, when a pair of subpanels are positioned side-by-side, will cooperate with a corresponding partial spline pocket of the adjacent subpanel to form a spline pocket 43 (also sometimes referred to as a spline connection area) for receiving a spline insert 45. During the assembly process, a spline insert 45 is inserted into the spline pocket(s) 43 between the two adjacent subpanels, and affixed thereto through a combination of adhesive and nails, thereby securing the two adjacent subpanels to each other. Generally speaking, the nails are important for securing the spline inserts to the subpanels while the adhesive has not yet fully cured; once the adhesive has dried/cured however, it is responsible for most of the bonding action. A spline insert can preferably be between 16×16 inches and 36×36 inches in size, and between ¾″ and 2″ in thickness (although appropriate dimensions of the splines can depend to some extent on the size and weight of the subpanels being connected together). In a preferred embodiment, the spline inserts are substantially square shaped, as shown; however, it should be understood that spline inserts of other shapes may also be used. The splines 45 are loaded on either end of the linear track in a spline stack 44, pre-stacked in reverse order of assembly, with the top spline being the first one to be assembled. The thickness of the splines and depth of the spline pockets may optionally be configured so that when a spline is inserted into a spline pocket, it's surface is generally flush with the level of the surface of the bottom or top segmented skin, as the case may be; alternatively, the splines extend beyond the level of the surface of the segmented skin or the splines may lie atop the subpanels.
iii. Interstitial ribs: The interstitial ribs (“ribs”) 48 are used to form the interstitial layer 54 (which is mostly hollow) of a structural panel. In an assembled structural panel, the ribs may span across various sections of the bottom segmented skin and/or multiple subpanels, and will help to join the subpanels together and provide additional structural strength to the structural panel as a whole. The ribs in the interstitial layer will generally be configured such that they are oriented in a combination of transversal and longitudinal directions (relative to the assembly table). Since these building parts are of an elongated nature, they may be loaded to a rib stack 50, which may be a wheeled cart with a comb-like rack facing upwards so that each rib can be placed vertically, with their longest dimension generally in the direction of the assembly table 24. The comb-like rack ensures that each rib 48 is placed in a known location despite differences in length, height, or width.
iv. Nails: Nail coils or magazines are directly loaded into the industrial robot's effector or nailing means 36.
v. Adhesive: The required adhesive for this process may be directly loaded into the industrial robot's effector or gluing means 33, which extends into a sled or cart on which the robot travels along the linear track. It is contemplated that any industrial adhesive suitable for use with wood/timber/engineered wood may be used for this purpose.
vi. All material carts in the first three points are loaded into the assembly process in a known location that is repeatable.

### Bottom Segmented Skin Assembly

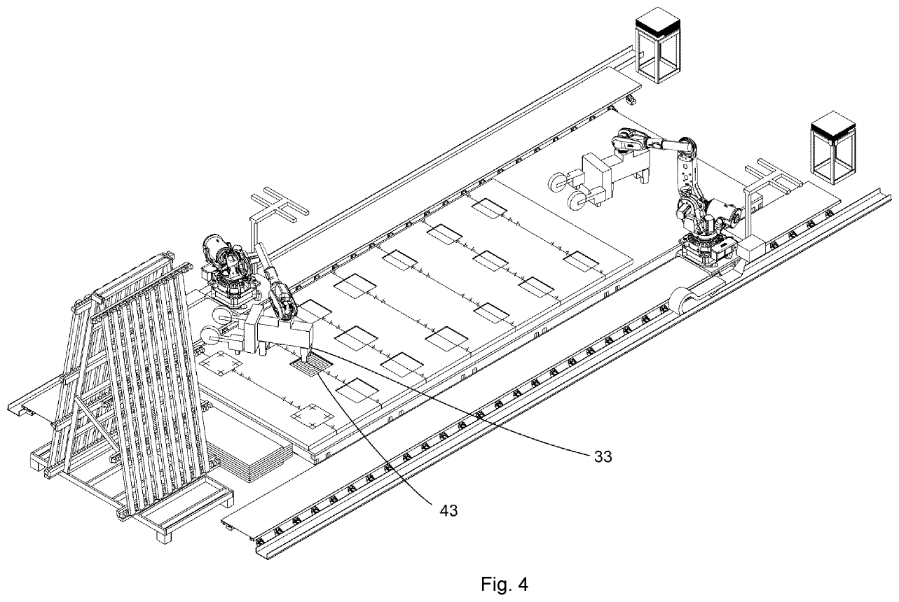

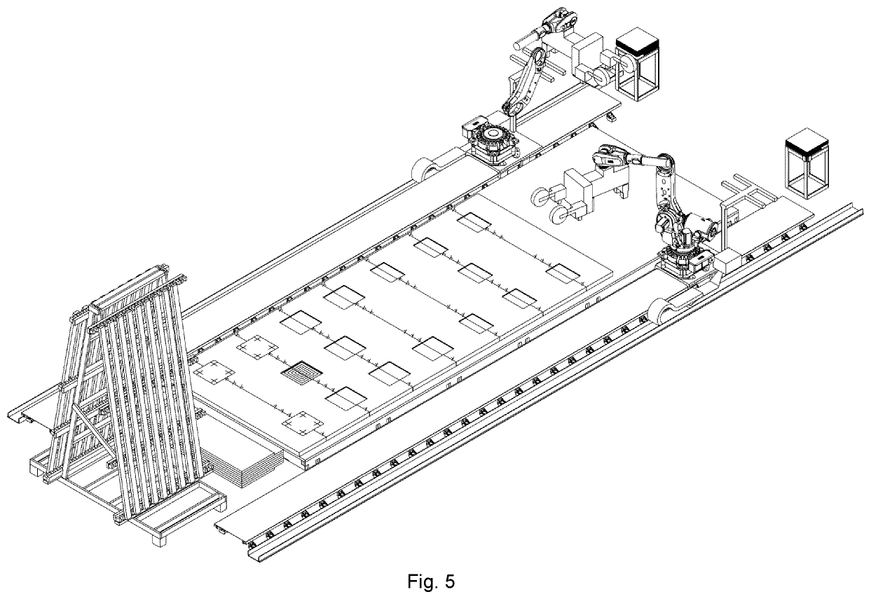

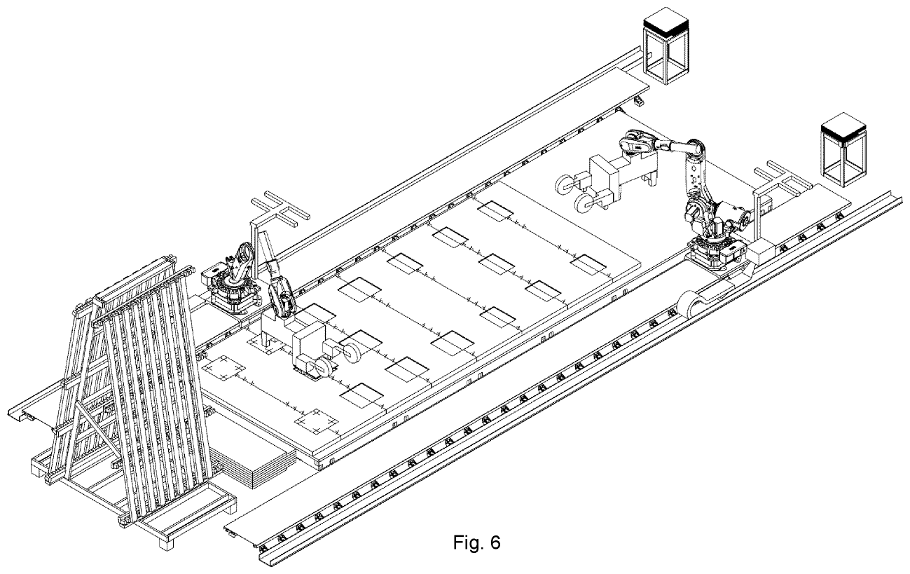

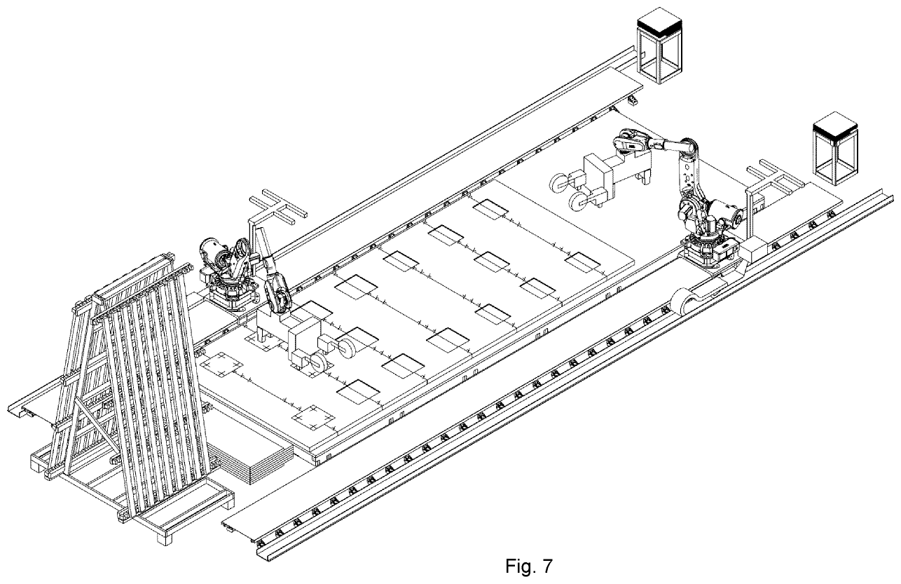

i. One or two robots pick up each subpanel 42 from the subpanel stack 39 and move them onto the assembly table 24. The first subpanel is placed/positioned at one end of the assembly table 42 closest to the building parts stacks. The next subpanel is placed next to the previous subpanel. This pick-and-place process is repeated for every subpanel 42 in the stack, and the specific location of each successive subpanel depends on the combined size of all previous subpanels. When a robot places a subpanel next to the previously placed subpanels, laser and camera measurements ensure there are minimal gaps between adjacent subpanels. This step in the assembly process is generally illustrated in FIGS. 1 and 2, where the robot 12 is shown picking up and positioning using the gripping means 30 multiple subpanels (which make up the bottom segmented skin) side-by-side on the assembly table 24. It is generally contemplated that the connecting edges of the subpanels (where one subpanel is to abut the edge of an adjacent subpanel) are square/flat; however, it is contemplated that the connecting edges may also be provided with simple, basic jointing or reciprocating jointing (e.g. such as grooves & insert or curved edges) to provide stronger connection between subpanels; however, this will generally introduce additional complexity to the automation process.
ii. Once the second subpanel is placed next to the first subpanel, one or multiple robots can begin applying adhesive to the pre-defined areas that represent the spline connection area or spline pockets 43. This is carried out for each spline pocket 43 on the bottom segmented skin 51. FIG. 4 illustrates the robot applying glue via the effector 27 and gluing means 33 to a spline pocket 43 overlapping two adjacent subpanels of the bottom segmented skin 51, in preparation for a spline to be inserted therein or applied thereupon.
iii. Next, one or multiple robots move to the spline stack 44, pick a spline, and position it on top of a spline pocket. This is repeated for each spline 45 and corresponding glued spline pocket 43 on the bottom segmented skin. FIG. 5 shows a robot picking up a spline 45 from a spline stack 44, and FIG. 6 shows the robot placing a spline into a glued spline pocket.
iv. Next, one or multiple robots temporarily affix the spline to the spline pocket and the subpanels using several sets (four as shown) of crossing nail connections, applied using the nailing means 36. The nails ensure that the spline connection stays fixed during the curing time of the adhesive. Preferably, the nails are crossed at 45 degree angles, so that they don't penetrate too far into the bottom segmented skin. FIG. 7 shows the robot nailing a spline across two adjacent subpanels of the bottom segmented skin. (While not specifically illustrated in the figures, if appropriate, crossing nail connections may optionally also be applied at the seams between the subpanels of the bottom segmented skin, in order to provide an additional mechanical connection between adjacent subpanels. This step can occur at any stage of the above described bottom segmented skin assembly process).

### Interstitial Rib Assembly

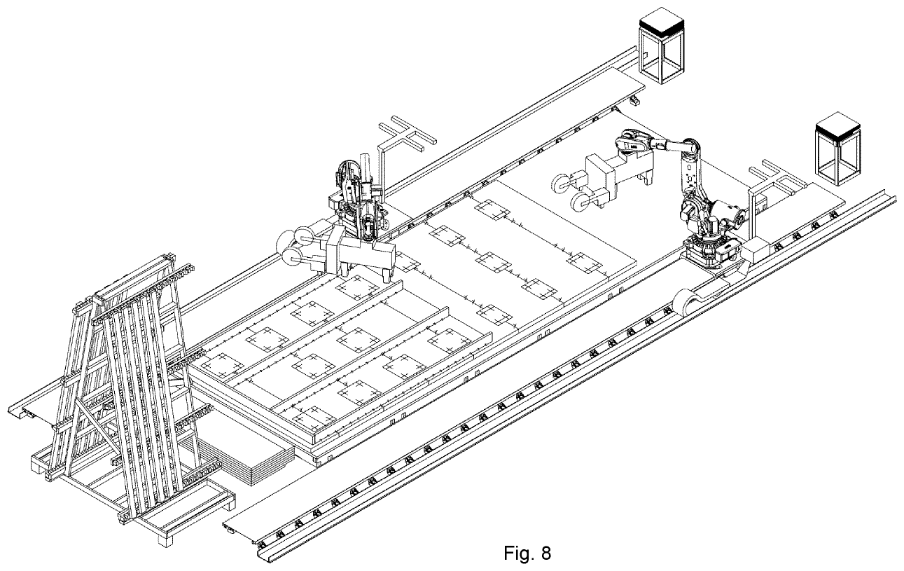

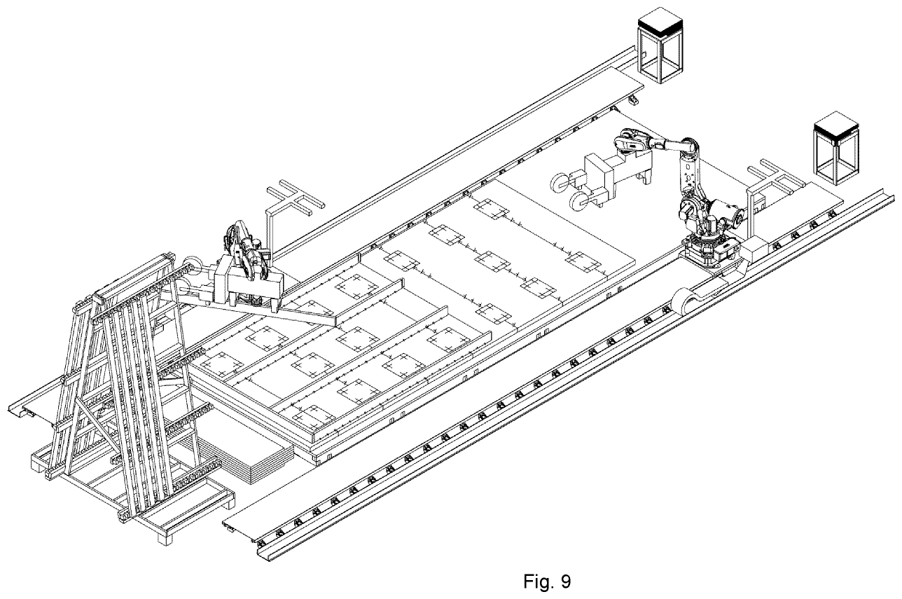

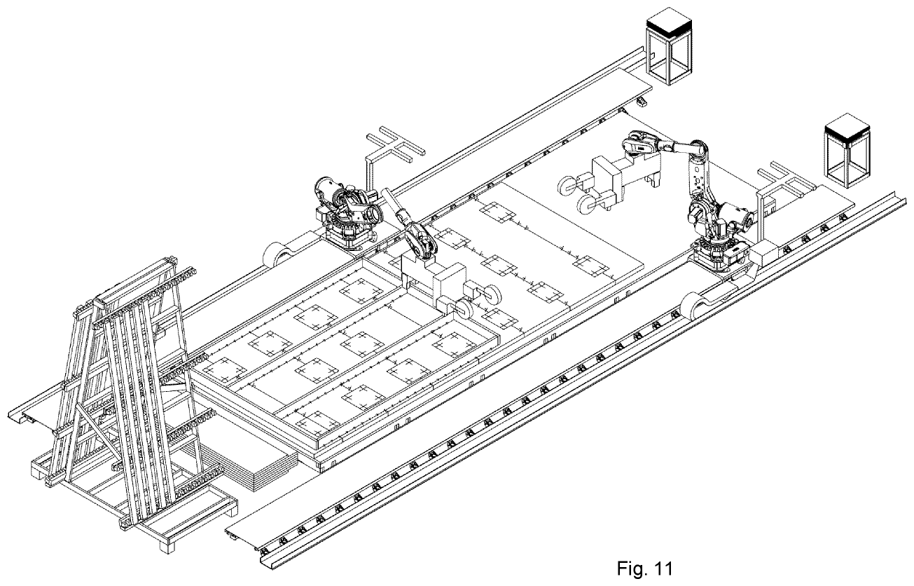

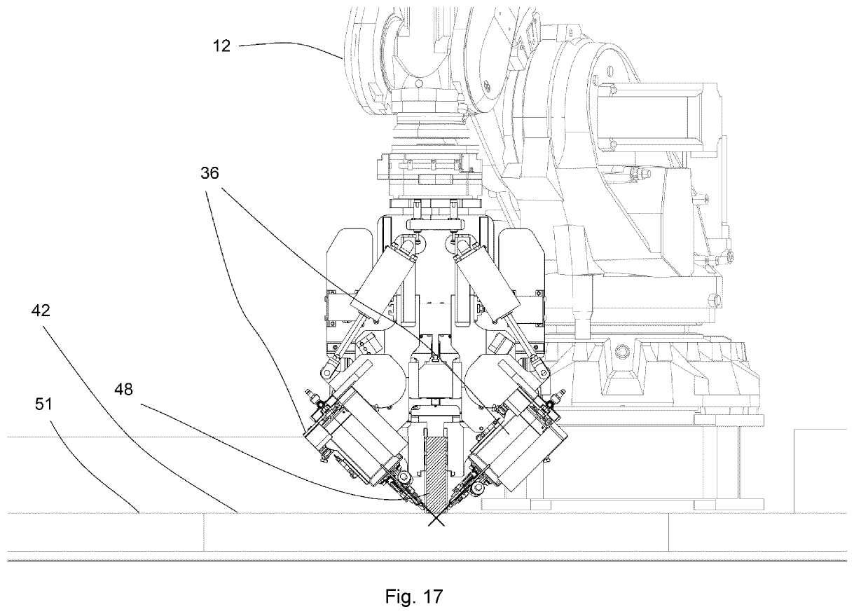

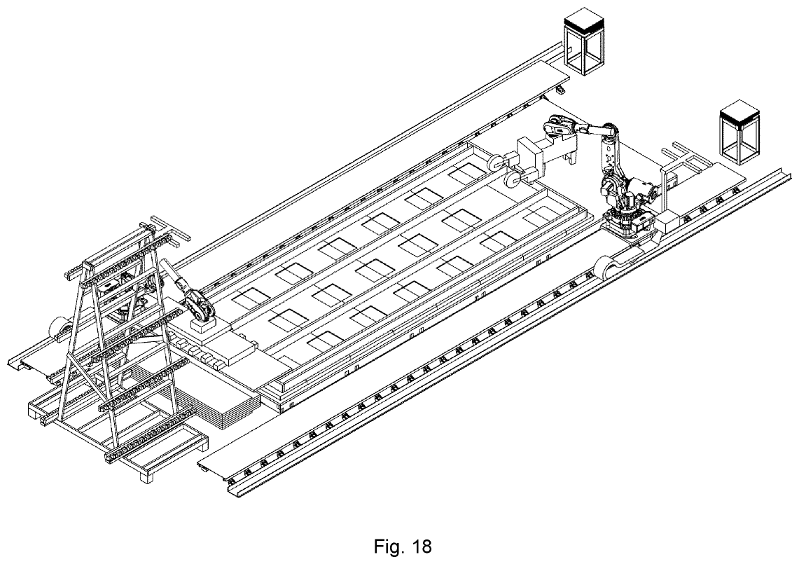

i. The layout of the interstitial rib defines the sequence of assembly: Transversal ribs are generally assembled first, followed by longitudinal ribs. The interstitial ribs are not connected to each other, but, in the assembled structural panel, they are connected to the bottom and top segmented skin 51, 57.
ii. Once the bottom segmented skin is assembled and connected, one or more multiple robots apply adhesive to the areas that will connect to any of the interstitial ribs (“rib locations”). FIG. 8 shows the robot applying adhesive to a rib location on the bottom segmented skin.
iii. Then, a robot will pick up the appropriate rib 48 from the rib stack 50 and place it into one of the appropriate rib locations. The rib will overlap with the adhesive that was applied in the previous step. This is repeated until the appropriate ribs are positioned over the bottom segmented skin, thereby forming an interstitial layer 54. FIG. 9 shows the robot positioning ribs to the rib locations atop the bottom segmented skin.
iv. Next, one or multiple robots will apply crossing nail connections (using the nailing means 36) near the bottom of each rib, ensuring that the nails penetrate through the ribs and into the bottom segmented skin. This connection ensures that the ribs are firmly connected to the bottom segmented skin while the adhesive cures. FIG. 11 shows the robot nailing a placed rib to the bottom segmented skin. FIG. 17 shows a side view of a portion of the assembly table, where the robot 12 and effector 27 equipped with nailing means 36 is nailing a rib to the bottom segmented skin, by nailing the rib near its bottom through to the bottom segmented skin, at 45 degree angles in a cross nailing fashion. FIG. 18 shows a variation of a structural panel, where the interstitial layer comprises additional longitudinal ribs spanning across some or the whole of the length of the structural panel, in order to provide greater structural strength to the panel (e.g. as shown, there are double sets of ribs on the outermost sides of the structural panel).

### Top Segmented Skin Assembly

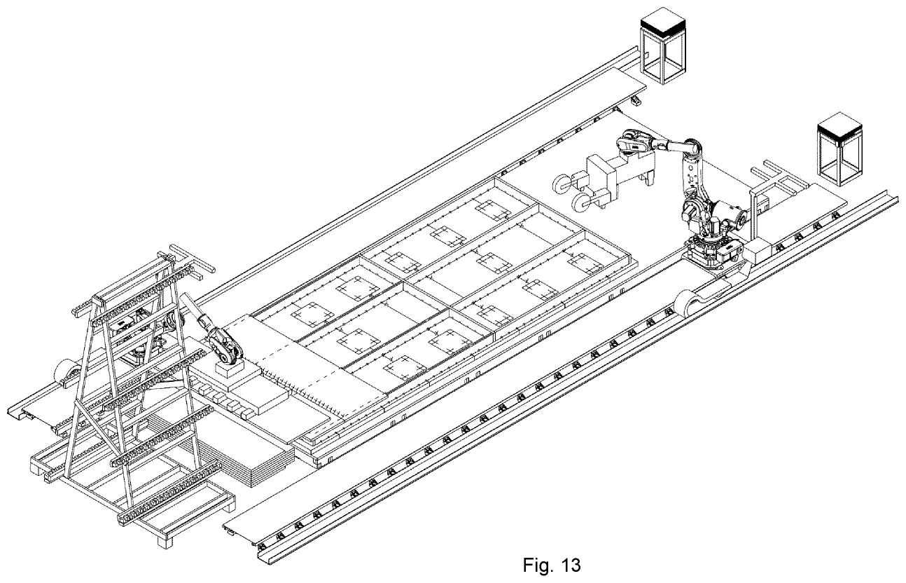

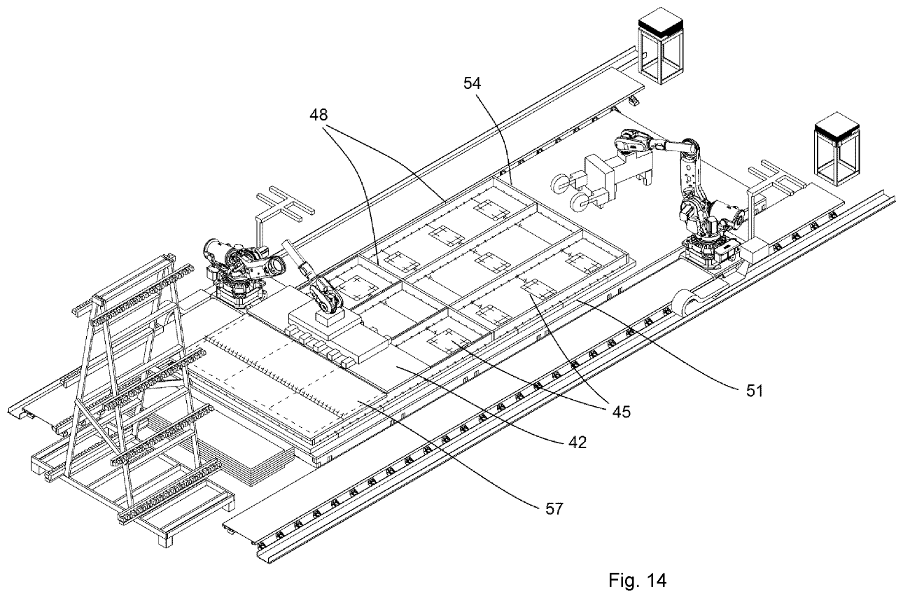

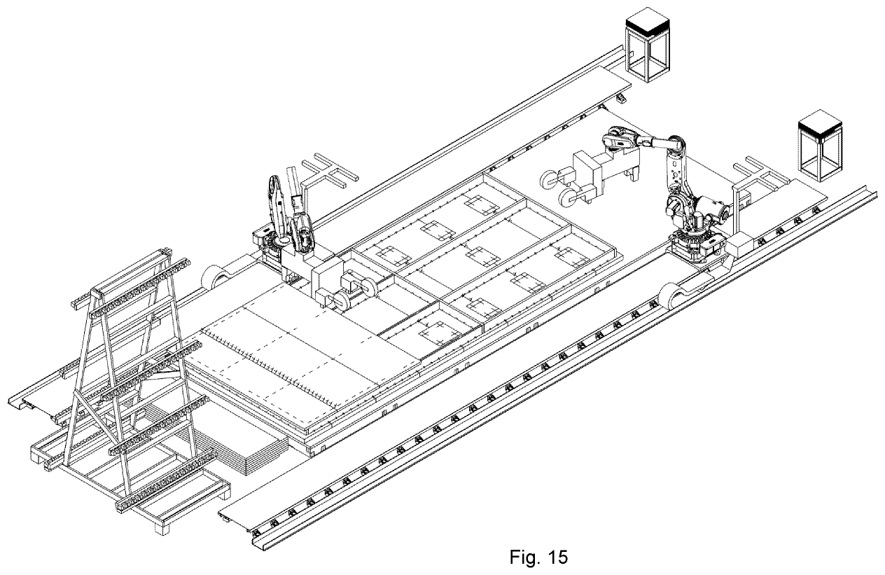

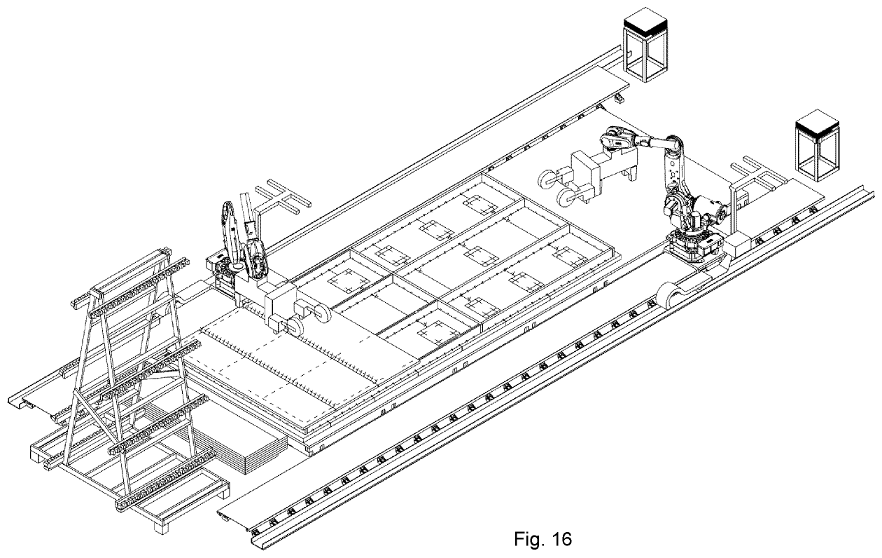

i. The size and sequence of assembly of the building parts of the top segmented skin 57 is very similar to that of the bottom segmented skin 51. The building parts are stacked in the same reverse order and picked and placed in a similar fashion. The subpanels that make up the top segmented skin may be configured to substantially mirror the configuration of the subpanels of the bottom segmented skin, i.e. such that each subpanel of the top segmented skin has a corresponding, similarly-sized subpanel on the bottom segmented skin. Alternatively, the subpanels of the top segmented skin may be configured so that they do not substantially mirror the configuration of the subpanels of the bottom segmented skin, i.e. such that the subpanels of the top segmented skin and the subpanels of the bottom segmented skin generally overlap each other (other than at the extreme ends of the top and bottom segmented skins); in some applications, this configuration may be desirable—e.g. this may provide for a more even distribution of forces/stresses across the fully-assembled structural panel.
ii Because the subpanels are to be placed on top of the interstitial ribs 48, the first step in this sub-process is to apply adhesive on top of the interstitial ribs.
iii. Next, one or more robots pick up each of the subpanels (which are to make up the upper segmented skin) from the subpanel stack and move them to their position on top of the interstitial ribs. FIG. 13 shows the robot picking up a subpanel using the gripping means 30, and FIG. 14 shows the robot positioning the subpanels (which are to make up the top segmented skin) side-by-side.
iv. Where required, analogous steps as described above for the assembly of the bottom segmented skin are taken (including the spline connection step).
v. In the case where no spline connection is required (e.g. due to lower structural requirements), crossing nail connections may be applied at the seams between the subpanels of the top segmented skin, in order to form a mechanical connection. The nails are crossed at 45 degree angles in order to form a better mechanical connection against tension or shear forces, and to accommodate longer nails for thinner materials. FIG. 15 shows the robot nailing the subpanel making up the top segmented skin to the nailed ribs. FIG. 16 shows the robot nailing the subpanels of the top segmented skin together.
vi. Once the assembly of the structural panel is completed, it can be rolled-off the assembly table, either for further finishing or to be transported to a construction site for building assembly.

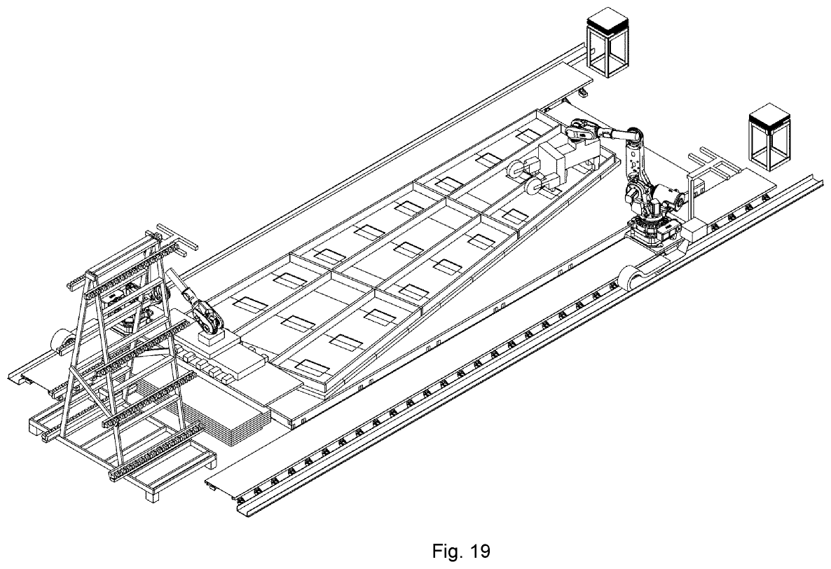

The above illustrates an exemplary process of assembling a specific structural panel as carried out by one preferred embodiment of the assembly system. The process may be utilised for structural panels of other dimensions and configurations, and possibly comprised of variations of subpanels. By way of example only, one variation is illustrated in FIG. 19, where the subpanels, instead of being substantially rectangularly-shaped, are instead configured and shaped (along with the corresponding ribs) to construct a structural panel wall which has a slope from end to the other (for ease of reference, the top skin is removed in order to show the bottom skin and the ribs of the interstitial layer); nevertheless, the same assembly process may be similarly applied, with relatively simple adaptation, to construct such sloped structural panel in an analogous manner as previously described.

As previously mentioned, one important aspect of the present assembly process is that it is highly adaptable and reconfigurable for different designs of structural panels, employing a parametric software workflow; the overall process for each different structural panel will be similar, with adjustments made to account for the differences in dimensions, configurations, etc. of the building parts. What this means in effect is that the software (and the software for providing handling instructions to the robots) can quickly be programmed as variations in the design of the structural panels are required (e.g. say a particular structural panel is to be made up of 8 “regular” subpanels, instead of 12 “regular” subpanels (e.g. where such is to be used for a side wall, instead of a full-length wall), or several of the subpanels are required to be of a different size in order to incorporate other features into a structural subpanel or to accommodate structural requirements of their connections with other parts of the building), instead of having to develop new handling routines for the robots to carry out the core assembly functions (pick-up/placing, gluing and nailing) from scratch each time. This high degree of adaptability allows for the process to be efficiently applied in the assembly and construction of all the component structural panels for a building, and allows for heavy automation to be more commercially feasible.

1. A structural panel made substantially from mass timber for use as a flooring panel or wall panel, the structural panel having a longitudinal axis and a transverse axis, comprising:
a bottom segmented layer, defining a first plane, the bottom segmented layer comprising a plurality of bottom subpanels, the bottom subpanels being substantially planar, arranged side-by-side in the first plane, and oriented in line with the transverse axis of the structural panel, with each bottom subpanel fixedly connected to one or more of its respective adjacent bottom subpanels;
a top segmented layer, defining a second plane, the top segmented layer comprising a plurality of top subpanels, the top subpanels being substantially planar, arranged side-by-side in the second plane, and oriented in line with the transverse axis, with each top subpanel fixedly connected to one or more of its respective adjacent top subpanels; and
an interstitial layer disposed between the bottom segmented layer and the top segmented layer, the interstitial layer comprising a plurality of elongate interstitial ribs oriented generally in line with the longitudinal axis of the structural panel, and defining a space between the bottom segmented layer and the top segmented layer, each of the plurality of interstitial ribs spanning over two or more of the plurality of bottom subpanels and over two or more of the plurality of top subpanels, and fixedly connected to the bottom segmented layer and to the top segmented layer;
wherein the first plane and the second plane are parallel with each other;
wherein each bottom subpanel is fixedly connected to its adjacent bottom subpanels by one or more bottom spline connections; and
wherein each top subpanel is fixedly connected to its adjacent top subpanels using a plurality of crossing nail connections or optionally using one or more top spline connections.

2. The structural panel of claim 1, wherein each of the bottom spline connections comprise a bottom spline overlapping said bottom subpanel and its adjacent bottom subpanel and the bottom spline is fixedly connected to the bottom subpanel and its adjacent bottom subpanel with adhesive.

3. The structural panel of claim 1, wherein each of the bottom spline connections comprise a first bottom spline pocket disposed proximate a side edge of the bottom subpanel, a corresponding second bottom spline pocket disposed proximate an adjacent side edge of the adjacent bottom subpanel, and a bottom spline insert,
wherein the first bottom spline pocket and second bottom spline pocket are configured to receive the bottom spline insert;
wherein the bottom spline insert overlaps said bottom subpanel and its adjacent bottom subpanel and is fixedly connected to the bottom subpanel and its adjacent bottom subpanel with adhesive.

4. The structural panel of claim 3, wherein a top surface of the bottom spline insert is flush with a top surface of the bottom segmented skin.

5. The structural panel of claim 1, wherein the interstitial ribs are fixedly connected to the bottom segmented layer and the top segmented layer using nails.

6. The structural panel of claim 5, wherein each of the plurality of interstitial ribs is fixedly connected to the bottom segmented layer by crossing nail connections applied proximate to a bottom interface between said interstitial rib and the bottom segmented layer, and each of the plurality of interstitial ribs is fixedly connected to the top segmented layer by crossing nail connections applied proximate to a top interface between said interstitial rib and the bottom segmented layer.

7. The structural panel of claim 1, wherein the structural panel is for use as a flooring panel or wall panel for a multi-storey building.

8. The structural panel of claim 1, wherein the bottom subpanels and top subpanels are made substantially from mass timber.

9. A method for constructing a structural panel made substantially from mass timber, for use as a flooring panel or as a wall panel, the method comprising the steps of:
providing a plurality of mass timber bottom subpanels;
orienting the plurality of bottom subpanels in line with a transverse axis of the structural panel and positioning the plurality of bottom subpanels side-by-side in a first plane upon an assembly table;
fixedly connecting each of the plurality of bottom subpanels to one or more of its respective adjacent bottom subpanels to form a bottom segmented layer, using one or more bottom spline connections, by applying adhesive to the spline connections using gluing means;
positioning a plurality of elongate interstitial ribs atop the bottom segmented layer to form an interstitial layer, each one of the interstitial ribs oriented generally in line with a longitudinal axis of the structural panel and spanning over two or more of the plurality of bottom subpanels;
fixedly connecting the plurality of interstitial ribs to the bottom segmented layer by applying nails through the interstitial ribs and the bottom segmented layer using nailing means;
providing a plurality of mass timber top subpanels;
orienting the plurality of top subpanels in line with the transverse axis of the structural panel, and positioning the plurality of top subpanels atop the interstitial layer, side-by-side in a second plane, wherein the second plane is parallel with the first plane;
fixedly connecting the plurality of interstitial ribs to the top segmented layer by applying nails through the interstitial ribs and the top segmented layer using nailing means; and
fixedly connecting each of the plurality of top subpanels to one or more of its respective adjacent top subpanels to form a top segmented layer, by (i) applying crossing nail connections along a respective seam between each top subpanel and its respective adjacent top subpanel or optionally by (ii) using one or more top spline connections and applying adhesive to the top spline connections using gluing means.

10. The method of claim 9, wherein the step of fixedly connecting the plurality of interstitial ribs to the bottom segmented layer comprises applying crossing nail connections proximate to a bottom interface between each said interstitial rib and the bottom segmented layer.

11. The method of any one of claims 9 and 10, wherein the step of fixedly connecting the plurality of interstitial ribs to the top segmented layer comprises applying crossing nail connections proximate to a top interface between each said interstitial rib and the top segmented layer.

12. The method of claim 9, wherein the step of fixedly connecting each of the plurality of bottom subpanels to one or more of its respective adjacent bottom subpanels to form a bottom segmented layer, using one or more bottom spline connections, comprises:
providing a first bottom spline pocket disposed proximate a side edge of the bottom subpanel, and providing a corresponding second bottom spline pocket disposed proximate an adjacent side edge of the adjacent bottom subpanel, and providing a bottom spline insert, wherein the first bottom spline pocket and second bottom spline pocket are configured to receive the bottom spline insert;
applying adhesive using gluing means to one or more of the first bottom spline pocket, the second bottom spline pocket and the bottom spline insert; and
affixing the bottom spline insert to the first bottom spline pocket and the second bottom spline pocket such that the bottom spline insert overlaps the bottom subpanel and its adjacent bottom subpanel and is fixedly connected to the bottom subpanel and its adjacent bottom subpanel with adhesive.

13. The method of claim 9, wherein the steps of orienting, position, nailing and applying adhesive are carried out by a robot equipped with one or more of a gripping means, effector means, nailing means and gluing means, the robot configured to move along a track disposed alongside the assembly table for assembling the structural panel.

14. A structural panel constructed in accordance with the method of any one of claims 9 to 13.
